(19) United States
(12) Patent Application Publication
(10) Pub. No.: US 2002/0170521 A1
(43) Pub. Date: Nov. 21, 2002

(54) Flat gasket for a reciprocating engine or a driven machine

(76) Inventor: Christoph Hilgert, Overath (DE)

Correspondence Address: KENYON & KENYON, ONE BROADWAY, NEW YORK, NY, 10004, US

(21) Appl. No.: 10/006,597

(22) Filed: Dec. 4, 2001

(30) Foreign Application Priority Data
Dec. 6, 2000 (DE) 100 60 514.1

(51) Int. Cl. F02F 1/00

(52) U.S. Cl. 123/193.5; 277/595

(57) ABSTRACT

A flat gasket for a reciprocating engine or a driven machine including at least one metal sheet 0.05 to 0.5 mm thick which is provided with a coating of an elastomer film at least on the sides facing outward in at least one sealing area and has an edge area, formed by the outer contour and/or at least one cylinder bore and/or a water and/or oil passage in the cylinder head, adjacent to at least one peripheral self-contained cavity, and the cavity is filled completely with a hydraulic medium.

### TECHNICAL SCOPE

The present invention relates to a flat gasket for a reciprocating engine or a driven machine including at least two laminated metal sheets 0.05-0.5 mm thick which are provided with a coating of an elastomer film at least on the side facing outward and have an edge area, formed by the outer contour and/or at least one cylinder bore and/or a water or oil passage in the cylinder head, adjacent to at least one peripheral first bead of one of the metal sheets, the second metal sheet bridging the first bead.

### BACKGROUND INFORMATION

Flat gaskets for internal combustion engines or driven machines are known in a variety of embodiments, e.g., from German Patents 195 31 232, 42 05 824 and 195 39 245. In the case of engines for commercial vehicles, such cylinder head gaskets have the function of sealing the joint between the cylinder head and the cylinder block. They are usually made of one or more metal sheets joined together to form a laminate and have one or more combustion chamber passage orifices and one or more liquid passage orifices, the latter permitting coolant water and/or lubricant oil to pass between the cylinder head and the cylinder block. With conventional cylinder head gaskets, a complete bead in an edge area often encloses and seals the combustion chamber passage orifices.

The liquid passage orifices are often also sealed by a bead surrounding the orifice in an edge area. On installation of the cylinder head gasket, the cylinder head and the engine block are pressed together by the bias force of the cylinder screws. The beads on the flat gasket lying between them are mutually supported against the adjacent sealing surfaces of the cylinder head or the engine block. The highest specific compressive load per unit area prevails in the immediate edge area of the combustion chamber passage orifices and in the area of the cylinder head screws. Stoppers surround the combustion chamber passages and act as deformation limiters. In addition to this static compressive load, the gasket is exposed to dynamic loads in operation of the engine. The distance between the sealing surfaces is not constant over time and space. Due to the periodic explosions in the combustion chamber, the cylinder head executes vertical and horizontal movements relative to the cylinder block. The amplitude of these sealing gap movements is greater, the greater the distance of the site in question from the cylinder head screws. A stationary condition over time cannot be achieved in the sealing gap either with the combustion chamber seal or the liquid seal. For a permanent and satisfactory seal, the gasket must be able to follow these relative movements for as long as possible through an elastically flexible response. The flat gasket must not lose its sealing elastic contact with the sealing surfaces of the cylinder block or the engine block. The functional lifetime of this elastic resiliency essentially limits the service life of the gasket. After a certain number of alternating load cycles, the spring characteristics of the flat gasket are reduced. At the end of the service life, leaking occurs in the seal of the combustion chambers or the chamber passage orifices.

### DESCRIPTION OF THE INVENTION

The object of the present invention is to provide a flat gasket having an improved sealing effect, a high elastic resiliency, low manufacturing costs and a long operating life.

This object is achieved according to the present invention with a flat gasket of the type defined in the preamble having the characterizing features of claim 1. The subclaims are based on advantageous embodiments.

According to the present invention, the combustion chamber passage orifice or the liquid passage or the outside contour is delimited in an adjacent edge area by a closed peripheral cavity of the gasket which is filled completely with a hydraulic medium. Due to the clamping force of the cylinder head screws, the flat gasket is pressed between the cylinder head and the cylinder block, so that a constant hydrostatic pressure develops in the cavity. The flexible tubular enclosure surrounding the cavity then adapts to the unavoidable distortion that occurs when clamping. The sealing contact with the sealing surfaces of the cylinder block and the engine block is not lost even when the cylinder head and cylinder block execute both relative vertical and horizontal movements during operation of the machine due to the ignition pressure. The hydraulic medium enclosed in the cavity causes a more uniform compressive sealing load over the circumference of the opening which is to be sealed. The elastic yielding behavior of the tubular enclosure improves the sealing effect in the operating condition of the machine and increases the service life of the flat gasket.

With regard to the manufacture and long-term stability of the gasket, it is advantageous for the metal sheet to be flanged back onto itself in the edge area, forming the cavity, and to join it to itself adjacent to the cavity. This connection may be a peripheral weld produced by electron beam welding, for example. This ring weld joins the edge of the metal sheet which has been bent over by 180° to the metal sheet itself and seals the cavity on the outside. The curve of the metal sheet turned toward the combustion chamber on the inside in the sealing gap is designed to be continuous. The peripheral bead-like thickened area forms an enclosure of a combustion chamber and simultaneously functions as a flame limiter and deformation limiter. Suitable hydraulic media include all materials that contribute toward a more uniform compressive sealing load over the periphery of the opening to be sealed. This also includes materials such as a solder which becomes molten at the operating temperature or plastically and/or elastically deformable polymer materials. It is especially preferable here if the polymer material is formed by a thermoplastic, rubber or silicone. These materials have a low chemical reactivity. The mechanical properties of the metal sheet enclosing the cavity are not impaired by chemical reactions between the hydraulic medium and the metal of the metal sheet.

It is preferable if the cavity is enclosed by at least one bead of the metal sheet and a second metal sheet bridging the bead, the two metal sheets being permanently joined together adjacent to the bead. In this construction, two laminated metal sheets are provided, one of which has a peripheral bead in the edge area of an orifice and the other bridges this bead. Permanent connection of the two metal sheets adjacent to the bead prevents a horizontal (as seen in the cross-sectional direction) yielding movement of the base of the bead under compressive load. The distance between the legs at the base of the bead supporting the bead is thus essentially maintained, despite the compressive force in the sealing gap. The result of this is a high elastic resiliency of the bead. This resiliency guarantees that the contact between the flat gasket and the sealing surfaces of the engine block or the cylinder head producing the actual sealing effect will be maintained even with relatively large sealing gap movements.

It is advantageous if the cavity is filled completely with a hydraulic fluid and the two metal sheets are joined in a fluid-tight manner. A high spring stiffness may be achieved, depending on the design of the bead. It is advantageous here if in the area of the bead the second metal sheet has a second bead which may have a design different from that of the first bead. Due to the differently designed beads, the flat gasket may be adapted very satisfactorily to the different materials of the cylinder head and the cylinder block with regard to frictional behavior. In cross section, the bead profile may have various shapes such as a U shape or a triangular shape. The sealing contact area of the flat gasket with the sealing surfaces of the cylinder head and cylinder block may thus be designed so that these sealing surfaces are not damaged due to pitting even after a lengthy operating time. The metal sheets may be made of the same or different materials, such as spring steel sheet of different thicknesses. It is of course also conceivable for other materials to be used, such as plastics instead of sheet metal. In a known manner, the gasket may be coated with an elastomer layer in the sealing area. This elastomer film may be a rubber layer, for example, applied by spraying or casting it onto the main sealing surfaces of the metal sheets. Due to the compressive forces in the sealing gap, this rubber layer is pressed into the surface roughness of the respective sealing surfaces, thus achieving a micro-sealing effect.

It is preferable if a third metal sheet is arranged between the first metal sheet and the second metal sheet and this third metal sheet is included in the connection between the first and second metal sheets, the cavities on both sides of the third metal sheet being in hydraulic connection with one another. This hydraulic connection may be formed by a flow-through opening in the third metal sheet. This embodiment yields a flat gasket having a high rigidity which maintains sealing contact even with large relative movements of the cylinder head relative to the engine block.

It is especially preferable here if the third metal sheet in the area of the first and second beads has a third bead having a differently shaped profile. Depending on the design and embodiment of this third bead, the elastic resiliency of the flat gasket may be preselected within broad limits. The hydraulic connection between the cavities prevents bulging of the third metal sheet enclosed between the two outer metal sheets. The flat gasket may be adapted very satisfactorily to the different materials used for the cylinder head and the cylinder block due to the beads which are designed with different cross sections. A round cross section or a bead composed of multiple partial beads increases the specific compressive loads per unit area with the adjacent sealing surface. The enlarged surface contact area with the sealing surface of the cylinder head prevents any digging into the surface. This is especially advantageous when the cylinder head is made of a light metal alloy.

### BRIEF DESCRIPTION OF THE DRAWINGS

To further illustrate the present invention, reference is made to the drawing in which figures schematically illustrate various embodiments according to the present invention.

FIG. 1 shows a partially sectional top view of the flat gasket according to the present invention.

FIGS. 2 through 7 show details of sections through preferred embodiments of the flat gasket according to the present invention.

### DESCRIPTION OF THE EMBODIMENTS

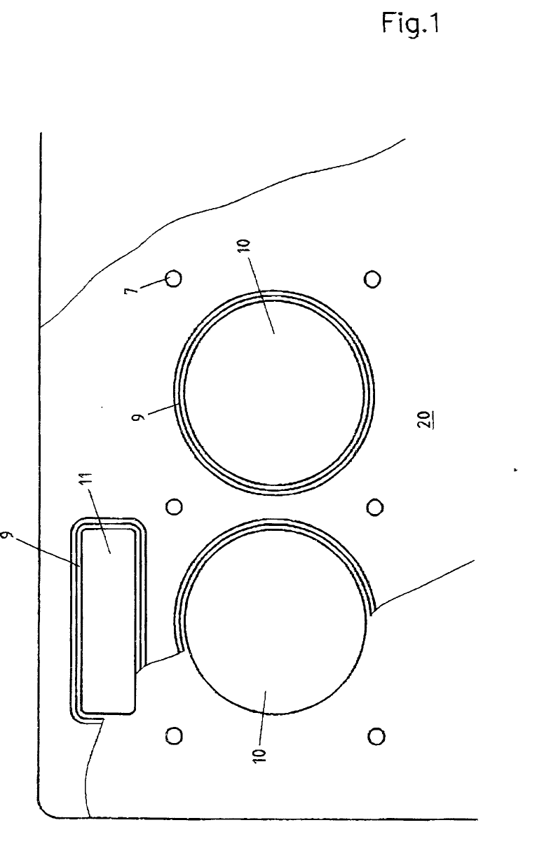

The flat gasket according to the present invention is shown in a top view in a partially sectional diagram in FIG. 1. Flat gasket 20 covers the sealing surfaces of an engine block or a cylinder head having cylinder bores 10 and liquid passage orifices 11. Each of these orifices 11, 10 is enclosed by a peripheral cavity bordered by metal sheet in an edge area 9. The outer contour of the flat gasket may also be provided with such a peripheral cavity. The decisive factor is always that the cavity is filled completely with a hydraulic medium, so that when there is a dynamic movement of the sealing gap, the medium is able to escape in the peripheral direction and may level out any differences in compressive forces. In FIG. 1 the cavity is bordered by a metal sheet edge flanged back onto itself. When the cylinder head and the engine block are pressed together by cylinder head screws in assembly, different specific compressive loads per unit area act locally on the flat gasket. The static pressure is greatest in the immediate vicinity of bores 7 of the cylinder head screws. As explained above, this static pressure is superimposed by dynamic sealing gap movements. In operation of the combustion engine, there are relative vertical and horizontal movements of the cylinder head with respect to the cylinder block. The amplitude of these sealing gap movements is greater, the greater the distance of the site in question from a cylinder head screw. The cavity which is provided according to the present invention and is filled completely with a hydraulic medium then causes the contact forces between the flat gasket and the sealing surfaces of the engine block or the cylinder head to be equalized.

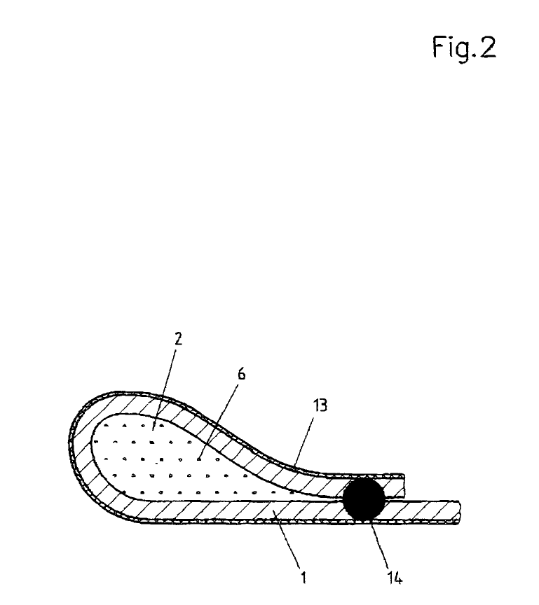

FIG. 2 shows a detail of a section through a preferred embodiment of the flat gasket according to the present invention. The edge of a metal sheet 1 surrounding an opening is flanged to form a closed cavity 2. This cavity 2 is filled completely with a hydraulic medium 6. All substances that cause the compressive sealing load to be more uniform are suitable for use as this hydraulic medium. During operation of the machine, this medium must circulate in the tubular enclosure so that the most uniform possible specific compressive load per unit area is maintained between the flat gasket and the respective sealing surface. The hydraulic medium may be a hydraulic fluid, for example. However, it is also conceivable to use a solder which becomes molten under operating conditions for the combustion gas [chamber] seal. However, polymer materials such as a thermoplastic, rubber or silicone may also be used. For a flat gasket, different substances may be used. As illustrated in the embodiment in FIG. 2, the edge of the metal sheet flanged back is joined to the metal sheet itself by a permanent connection 14. This connection 14 may be produced inexpensively by electron beam welding, for example, so it is fluid tight. The sealing area of the gasket is coated with an elastomer layer 13.

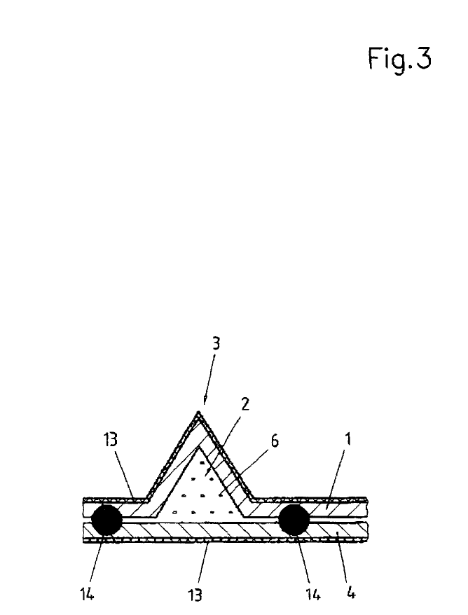

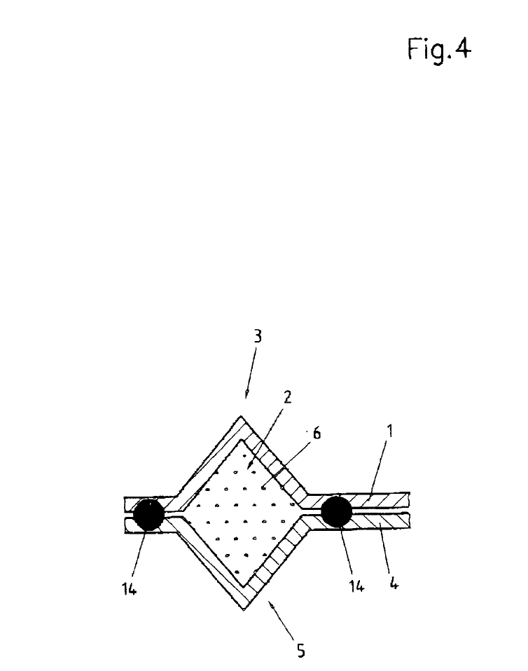

FIG. 3 shows an especially preferred embodiment as a detail of a section of the flat gasket. In this embodiment, cavity 2 is formed by bead 3 of a metal sheet 1 covered by a second metal sheet 4. Both metal sheets 1, 4 are permanently joined by a connection 14 on both sides of bead 3. The metal sheets may be 0.05 mm to 0.5 mm thick. For micro-sealing, both metal sheets 1, 4 are coated with an elastomer layer 13. Metal sheet 4 may be designed to be flat or, as shown in FIG. 4, it may have a bead opposite bead 3. The resiliency of the flat gasket may thus be adapted optimally.

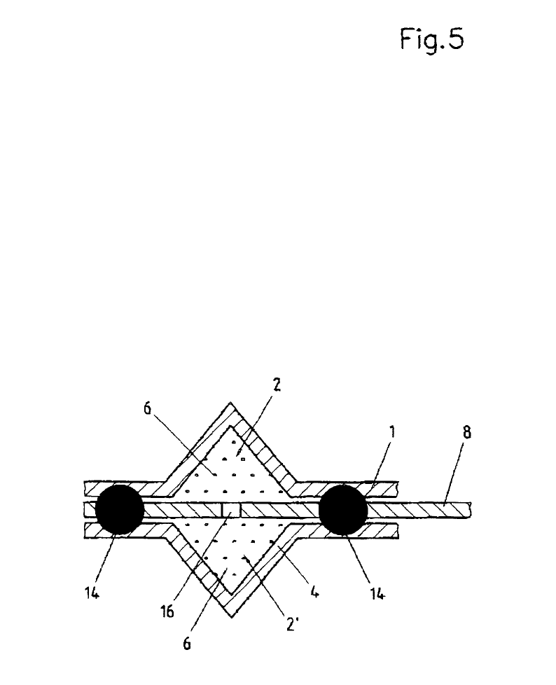

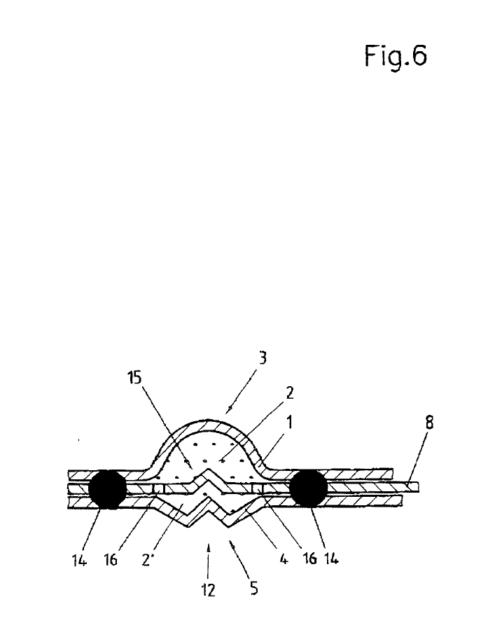

The sectional drawings in FIGS. 5 and 6 each show an especially preferred embodiment of the present invention. Between two metal sheets 1 and 4 is situated a third metal sheet 8. Connection 14 connects three metal sheets 1, 8, 4 in a bonded manner on both sides of each bead. This forms two cavities 2, 2′, each filled with a hydraulic medium. A passage orifice 16 in metal sheet 8 in between forms a hydraulic connection between cavities 2, 2′ adjacent to metal sheet 8. As shown in FIG. 6, metal sheet 8 may also have a bead 15 in the area of adjacent cavities 2, 2′, thus increasing the elastic resiliency of the flat gasket. The different cross-sectional shapes of beads 5 and 3 may be adapted very satisfactorily with regard to differences in frictional behavior of the respective materials of the cylinder head and the cylinder block. The contact area of the flat gasket with the planar sealing surfaces of these machine parts may thus be designed so that the sealing surfaces are not damaged even after a comparatively long period of operation.

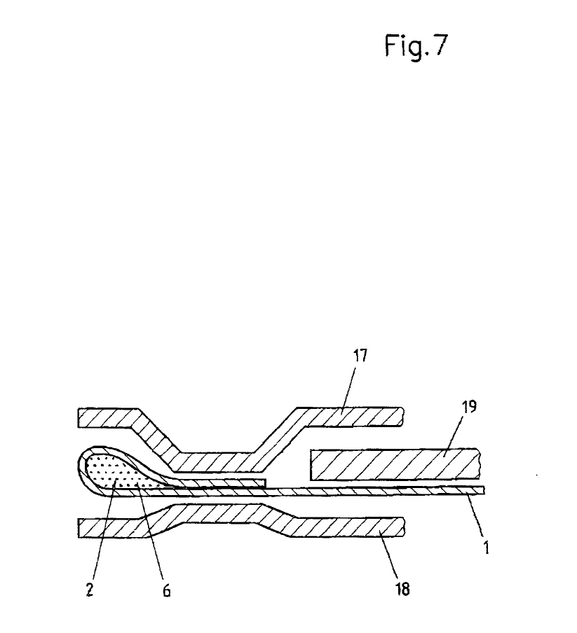

A preferred embodiment of the present invention is illustrated in FIG. 7. Here again, cavity 2 bordering the opening is formed by the edge of metal sheet 1 which is flanged back onto itself. However the bent-back edge is not welded but instead is pressed between two beads of active layers 17 and 18 by the bias tension of the cylinder head screws. Between layers 17 and 18, an intermediate layer 19 is situated adjacent to the flanged-back edge. Hydraulic medium 6 enclosed in the cavity may be a plastically deformable polymer material such as a thermoplastic, rubber or silicone. In FIG. 7, layers 17 and 18 enclose cavity 2 like a sandwich. The flat gasket may of course also be designed so that only one active layer 17 or 18 is present. To compensate for surface defects such as porosity or shrink holes on the sealing surface of the cylinder block or engine block, the flat gasket according to the present invention may also include cover layers on the outside.

What is claimed is:

1. A flat gasket for a reciprocating engine or a driven machine including at least one metal sheet 0.05 to 0.5 mm thick which is provided with a coating of an elastomer film at least on the sides facing outward in at least one sealing area and has an edge area, formed by the outer contour and/or at least one cylinder bore and/or a water and/or oil passage in the cylinder head, adjacent to at least one peripheral self-contained cavity,
wherein the cavity (2) is filled completely with a hydraulic medium (6).

2. The flat gasket for a reciprocating engine or a driven machine according to claim 1,
wherein the metal sheet (1) is flanged back onto itself in the edge area, forming the cavity (2), and is joined to itself adjacent to the cavity.

3. The flat gasket for a reciprocating engine or a driven machine according to claim 1,
wherein the cavity (2) is enclosed by at least one bead (3) of the metal sheet (1) and a second metal sheet (4) bridging the bead, which are permanently jointed together adjacent to the bead.

4. The flat gasket for a reciprocating engine or a driven machine according to claim 3,
wherein the metal sheet (1) and the second metal sheet (4) are joined in a fluid-tight manner.

5. The flat gasket for a reciprocating engine or a driven machine according to claim 3,
wherein in the area of the bead (3) the second metal sheet (4) has a second bead (5).

6. The flat gasket for a reciprocating engine or a driven machine according to claim 5,
wherein the second bead (5) has a different design from that of the first bead (3).

7. The flat gasket for a reciprocating engine or a driven machine according to claim 5 or 6,
wherein the second bead (5) has a profile with a smaller cross section than the first bead (3).

8. The flat gasket for a reciprocating engine or a driven machine according to one of claims 3 through 7,
wherein the second metal sheet (4) has a second bead (5) in mirror image to the bead (3) of the first metal sheet (1).

9. The flat gasket for a reciprocating engine or a driven machine according to one of the preceding claims,
wherein a third metal sheet (8) is arranged between the first metal sheet (1) and the second metal sheet (4); and the third metal sheet is included in the connection between the first and second metal sheets; and the cavities (2) on both sides of the third metal sheet are in hydraulic connection (16) with one another.

10. The flat gasket for a reciprocating engine or a driven machine according to claim 9,
wherein the third metal sheet (8) in the area of the first and second beads has a third bead (15) having a differently shaped profile.

11. The flat gasket for a reciprocating engine or a driven machine according to claim 10,
wherein the first, second and/or third beads are subdivided into at least two partial beads (12).

12. A cylinder head gasket according to one of claims 1 through 9,
wherein at least two cylinder head gaskets are included according to at least one of claims 1 through 11.

13. The flat gasket for a reciprocating engine or a driven machine according to one of the preceding claims,
wherein each cavity (2) is filled with a substance that is liquid at least under operating conditions.

14. The flat gasket for a reciprocating engine or a driven machine according to claim 13,
wherein the substance is formed by a solder.

15. The flat gasket for a reciprocating engine or a driven machine according to one of claims 1 through 12,
wherein the cavity is filled with a polymer material that is plastically and/or elastically deformable at least under operating conditions.

16. The flat gasket for a reciprocating engine or a driven machine according to claim 15,
wherein the polymer material is formed by a thermoplastic, rubber or silicone.
